(19) United States
(12) Patent Application Publication
(10) Pub. No.: US 2013/0134226 A1
(43) Pub. Date: May 30, 2013

(54) RADIO FREQUENCY IDENTIFICATION LIBRARY SLANTED CAVITY DEVICE

(71) Applicant: ClarlDy Solutions, Inc., Hsinchu City (TW)

(72) Inventor: HORNG-JI CHEN, Hsinchu (TW)

(73) Assignee: ClarIDy Solutions, Inc., Hsinchu City (TW)

(21) Appl. No.: 13/662,761

(22) Filed: Oct. 29, 2012

(30) Foreign Application Priority Data
Nov. 28, 2011 (TW) 100143549

(51) Int. Cl. G06K 19/07

(52) U.S. Cl. CPC G06K 19/0723
USPC 235/492

(57) ABSTRACT

A radio frequency identification apparatus for a book management operation is disclosed, which is an RFID library slanted cavity device configured with a non-metallic slanted cavity for users to place and pick items or books conveniently. The RFID library slanted cavity device is configured with RFID readers for accessing information from books or audio/video multimedia items that are operated by users, by that not only the efficiency of the RFID readers to access the RFID tags attached to the books or multimedia items can be enhanced, but also the output power of the RFID readers can be lower for reducing electromagnetic wave leakage to ambient environment, while still working with satisfactory access efficiency. With the aforesaid device, the accuracy of a self-service operation can be enhanced by its ergonomics design, and also a book management operation can be performed efficiently since the RFID tag attached to books can be accessed effectively.

### FIELD OF THE INVENTION

The present invention relates to a radio frequency identification (RFID) apparatus adapted for a book management operation, which is an RFID library slanted cavity device configured with a non-metallic slanted cavity for allowing users to place and pick items or books conveniently. Moreover, the RFID library slanted cavity device is configured with RFID readers for accessing information from books or audio/video multimedia items that are operated by users, by that not only the efficiency of the RFID readers to access the RFID tags attached to the books or multimedia items can be enhanced, but also the output power of the RFID readers can be lower down for reducing electromagnetic wave leakage to ambient environment, while still working with satisfactory access efficiency. The aforesaid RFID library slanted cavity device is designed to be easily integrated with a lot of book management operating devices, such as an automatic book self-service machine, a library staff workstation, a RFID tag converting station, a mobile library book cart, and so on. With the aforesaid device, the accuracy of a self-service operation by any user can be enhanced by the ergonomics design of the aforesaid device, and also a book management operation can be performed efficiently since the RFID tag attached to books can be accessed effectively.

### BACKGROUND OF THE INVENTION

Radio-frequency identification (RFID) is a technology that uses communication via radio waves to exchange data between a reader and an electronic tag attached to an object, for the purpose of identification and tracking. Generally, an radio-frequency identification system involves RFID readers, RFID tags, and an application system. It is noted that the RFID system can be designed to operate using RFID tags of different radio frequencies under different regulations, including low-frequency (LF) RFID tags at 134 KHz typically, high-frequency (HF) RFID tags at 13.56 MHz, ultra-high-frequency (UHF) RFID tags at 860˜960 MHz, and microwave RFID tags at 2.4 GHz, and so on. The passive RFID tags have no power source internally and require an external electromagnetic field, that is mostly emitted from RFID readers, to power and activate an internal analog circuit embedded in the passive RFID tags for the chip operations. Generally, such RFID tag can be embedded with memories for data storage, and the memories can be read-only memories (ROM), write-once-read-many (WORM) memories or rewritable memories (such as EEPROM). Currently, each of the high-frequency (HF) RFID tags that are available on the market is embedded with its own unique ID (UID). In a new UHF RFID tag available in the market, if the tag conforms to a communication protocol of an Electronic Product Code (EPC), in addition to a chip manufacturer code and chip type data on a Tag ID (TID), a set of chip serial numbers also exists on the TID, a capacity of which varies from 32 bits to 64 bits according to a chip type of the manufacturer. The application system may use the related UID or the chip serial numbers according to the requirements in use for anti-counterfeit processing. An RFID reader supplies power to a passive RFID tag for operation, which is named “RFID reader”, but actually has functions of reading and writing data in the memory of the RFID tag. Only when the operating frequency of the RFID system is the same as that of the communication protocol, the RFID system can be normally used.

For those conventional book self-service machines, the books being processed are generally placed to a flat, planar platform for allowing the RFID tags attached thereto to be accessed. Thus, when there are more than one books being placed, those books will be stacked up one by one naturally. However, it is difficult to access the RFID tags of the books easily and accurately when there are too many books stacking on the platform. In response to that, the common act is to increase the output power of the machine's RFID readers as high as possible so as to enhance their accessibility to the RFID tags attached to the stack of books. Nevertheless, such operation will generally cause a portion of electromagnetic wave from the RFID readers to be emitted beyond the predefined access region of the book self-service machine, resulting that the RFID tags of books be carried by the other users are mistakenly accessed by the RFID reader of the book self-service machine simultaneously and cause book management and equipment utilization problems.

It also common to some conventional book self-service machines that the books being processed are placed also to a flat, planar platform, but the platform is further configured with metallic shielding walls at the right side, left side and the rear side of the platform, allowing only its front to be opened so as to be used as book entrance and exit. Thereby, the electromagnetic wave from the RFID readers can be reduced from emitting beyond the predefined access region of the book self-service machine, and thus the amount of erroneous RFID access can be reduced. In some cases, there are some book platforms that are additionally formed with several bar-like ridges so as to enable the books to stand vertically. Generally, the metallic shielding walls that are arranged at the right side, the left side and the rear side of the book platform are higher than 15 cm, resulting that it is difficult to fetch multiple bookssimultaneously when they are standing vertically, and especially, it is difficult to fetch those books that are placed near to the shielding walls.

### SUMMARY OF THE INVENTION

In view of the disadvantages of prior art, the object of the present invention is to provide a radio frequency identification (RFID) library slanted cavity device, adapted for a book management operating system for processing an item, is disclosed, which comprises:
a metal box;
at least one RFID tag, each having an identification code registered in an internal memory of the RFID tag and provided to be attached to the item for identification;
an RFID reader antenna, disposed inside the metal box for sensing the at least one RFID tag that is attached to the item while transmitting a sensing signal to an RFID reader; and
a non-metallic slanted cavity, disposed inside the metal box to be provided for the item having the RFID tag attached thereto to be placed thereon so as to enable a book management operation.

Preferably, the RFID reader antenna is an antenna selected from the group consisting of: a circular polarization antenna, a dual polarization antenna, and a linear polarization antenna.

Preferably, the at least one RFID tag is substantially an ultra-high-frequency (UHF) RFID tag.

Preferably, the RFID reader antenna is electrically connected to the RFID reader when the RFID reader is embedded in the RFID library slanted cavity device, or is connected to the RFID reader through a RF coaxial cable when the RFID reader is arranged outside the RFID library slanted cavity device, by that the RFID reader is enabled to access the at least one RFID tag; and the item can be an object selected from the group consisting of: a book and an audio/video multimedia item.

Preferably, the non-metallic slanted cavity is made of a non-metallic material, and is provided for the item to be placed thereat so as to enable the book management operation to be performed upon the at least one RFID tag; and the non-metallic material is a material selected from the group consisting of: plastic, wood, paper, ceramics and glass.

Preferably, the metal box is composed of five metal plates, including a front plate, a rear plate, a left plate, a right plate and a bottom plate, and by the shielding of those five metal plates, the electromagnetic wave emitting from the RFID reader antenna is restricted to be transmitted upward through the top of the metal box.

Preferably, the non-metallic slanted cavity is composed of a non-metallic slanted plate, a non-metallic baffle and two non-metallic sidewalls. Moreover, the non-metallic baffle is formed with a height ranged between 4 cm to 15 cm; and the non-metallic slanted plate is disposed forming an inclined angle ranged between 80 degrees and 110 degrees inside the non-metallic slanted cavity.

Preferably, the book management operating system is a device selected from the group consisting of: an automatic book self-service machine, a library staff workstation, a RFID tag converting station, and a mobile library book cart, etc.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A, FIG. 1B, FIG. 1C and FIG. 1D are respectively a top view, a lateral cross sectional view, a longitudinal cross sectional view and a three-dimensional view of an RFID library slanted cavity device according to an embodiment of the invention.

FIG. 2A, FIG. 2B, FIG. 2C and FIG. 2D are cross sectional diagrams showing how items can be placed and stacked inside the RFID library slanted cavity device of the invention.

FIG. 3A and FIG. 3B are schematic diagrams showing respectively a vertical-type automatic book self-service machine and a seat-type automatic book self-service machine.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

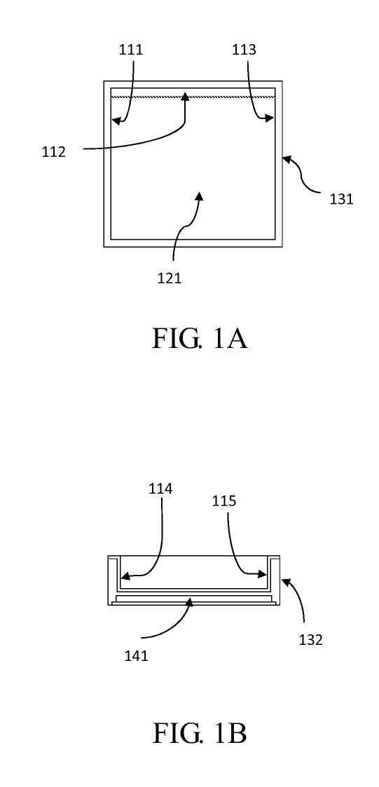

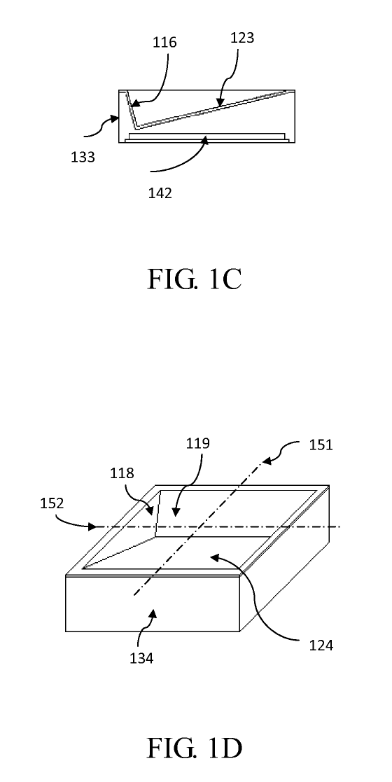

Please refer to FIG. 1A, FIG. 1B, FIG. 1C and FIG. 1D, which are respectively a top view, a lateral cross sectional view, a longitudinal cross sectional view and a three-dimensional view of an RFID library slanted cavity device according to an embodiment of the invention. In this embodiment, the RFID library slanted cavity device has a metal box 131, 132, 133, 134 that is composed of five metal plates, i.e. a front plate, a rear plate, a left plate, a right plate and a bottom plate, and is used for receiving an RFID reader antenna 141, 142 therein, whereas the RFID reader antenna 141, 142 is connected to a RFID reader in a manner selected from the group consisting of: the RFID reader antenna is electrically connected to and integrated with the RFID reader, and the RFID reader antenna is connected to the RFID reader through a RF coaxial cable. Therefore, by the shielding of those five metal plates, the electromagnetic wave emitting from the RFID reader antenna is restricted to be transmitted upward through the top of the metal box 131, 132, 133, and 134. Moreover, it is noted that when the RFID reader is electrically connected to the RFID reader antenna 141, 142, the RFID reader is also being receiving inside the metal box 131, 132, 133, 134; and when RFID reader is connected to the RFID reader antenna 141, 142 through a RF coaxial cable, the RFID reader is arranged outside or inside metal box 131, 132, 133, 134 depending upon actual design requirements. The RFID reader is designed to emit electromagnetic wave through the RFID reader antenna 141, 142 so as to interrogate with an RFID tag attached to a book or an audio/video multimedia item. In addition, there is a non-metallic slanted plate 121, 123, 124 disposed inside the metal box 131, 132, 133, 134 in a manner that one end of the non-metallic slanted plate 121, 123, 124 is arranged near to the top rim of the metal box 131, 132, 133, 134 while allowing another end thereof to be arranged near to the top of the RFID reader antenna where it is coupled to a non-metallic baffle 112, 116, 119. The non-metallic slanted plate 121, 123, 124 is provided for allowing items, such as books, to be placed thereon; and by the near perpendicular angle formed between the non-metallic baffle 112, 116, 119 and the non-metallic slanted plate 121, 123, 124, the non-metallic baffle 112, 116, 119 is provided for supporting the items that are placed on the non-metallic slanted plate 121, 123, 124 so as to enable those items to stack on one another in a near vertical standing position. Therefore, the non-metallic slanted plate 121, 123, 124 should be formed with a length much longer than that of the non-metallic baffle 112, 116, 119, whereas the height of non-metallic baffle 112, 116, 119 that is extending in a direction perpendicular to the non-metallic slanted plate 121, 123, 124 should be limited for providing easy access to the items that are placed on the non-metallic slanted plate 121, 123, 124. Since most books or audio/video multimedia items are formed as a rectangle, the included angle that is formed between the non-metallic slanted plate 121, 123, 124 and the non-metallic baffle 112, 116, 119 is preferred to be a 90-degree angle, by that not only there can more items to be placed and stacked on the non-metallic slanted plate 121, 123, 124, but also the RFID tags attached to those items can be accessed easily and effectively. Moreover, there are two non-metallic sidewalls 111, 113, 114, 115, 118 coupled respectively to the two opposite sides of the non-metallic slanted plate 121, 123, 124, that are provided for strengthening the structural strength of the non-metallic slanted plate 121, 123, 124 for allowing the non-metallic slanted plate 121, 123, 124 to support the weights of a plurality items that are being placed thereon. For preventing the items, such as books or audio/video multimedia items, from slipping on the non-metallic slanted plate 121, 123, 124 and thus falling flatly instead of standing vertically, the surface of the non-metallic slanted plate 121, 123, 124 can be coated or attached with an anti-slip abrasive material. In this embodiment of the invention, the non-metallic slanted plate 121, 123, 124, non-metallic baffle 112, 116, 119, and the non-metallic sidewalls 111, 113, 114, 115, 118 can be made of a non-metallic material; and the non-metallic material is a material selected from the group consisting of: plastic, wood, paper, ceramics and glass, and the like.

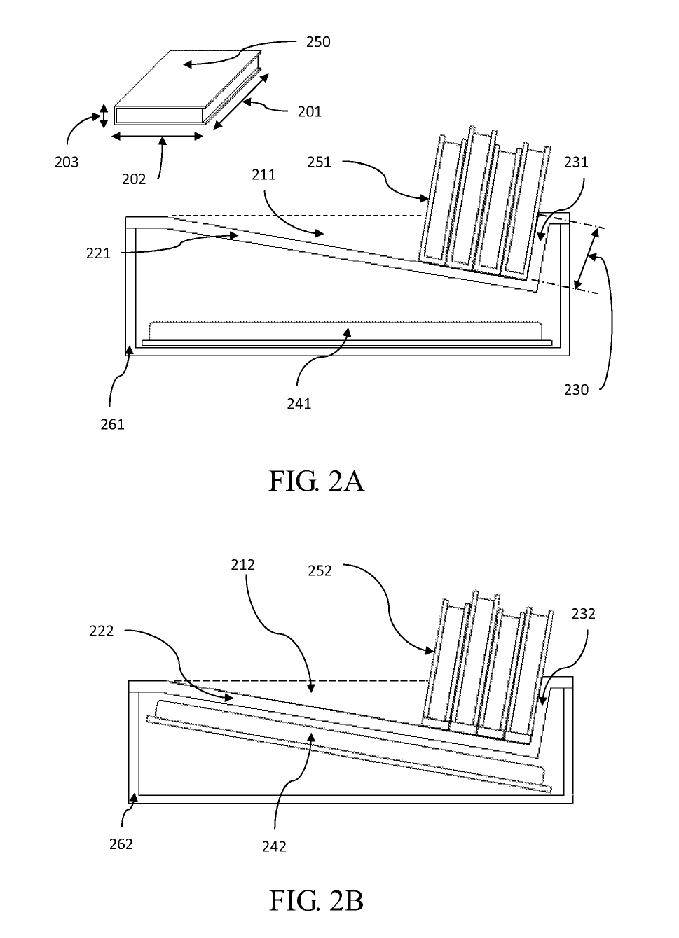

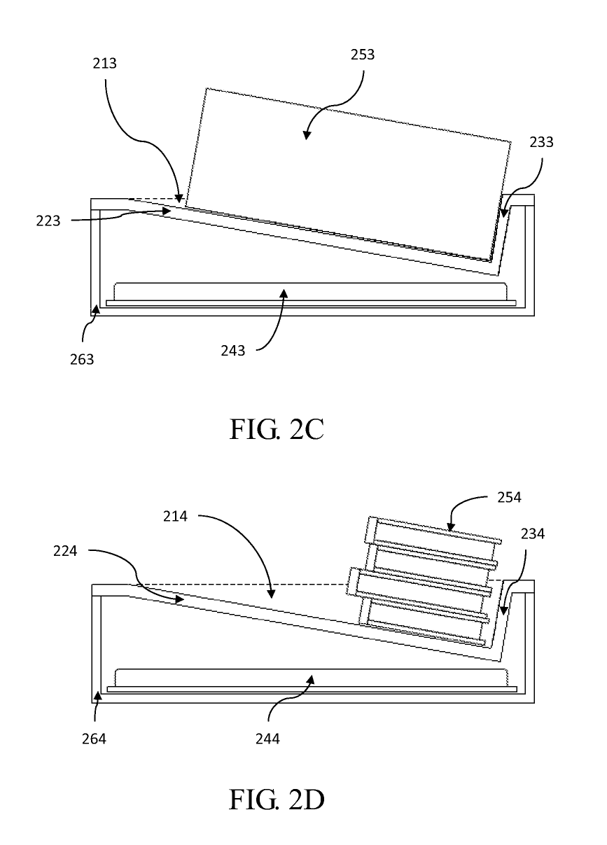

Please refer to FIG. 2A, FIG. 2B, FIG. 2C and FIG. 2D, which are cross sectional diagrams showing how items can be placed and stacked inside the RFID library slanted cavity device of the invention. As shown in FIG. 2A, FIG. 2B, FIG. 2C and FIG. 2D, each item 250, 251, 252, 253, 254, such as a book or an audio/video multimedia item, has an RFID tag attached thereat. For clarity, the item is defined to be a book in the following description for illustration, which is formed in a length 201, a width 202 and a thickness 203. It is noted that the shape and size of an RFID tag can decide where is the best position on a book for the tag to be attached to; and the RFID tag that is larger in size is best to be attached to the cover of a book or the inner side of the cover, but its invisibility is poor and thus it is usually being covered behind a paper tag or other sealing materials. On the other hand, when the RFID tag is a small, narrow bar-like object, it can be located proximate to the spine of a book, and thereby, its invisibility is greatly enhanced. Currently, the ultra-high-frequency (UHF) RFID tags for library usage are most commonly being designed as a small, narrow bar-like style. Moreover, each of the RFID tags is programmed with an identification code that is registered in its internal memory, whereas such identification code can be the UID of the RFID tag that is given during manufacture, or can be a multi-purpose code that is coded according to the UID and given to the RFID tag for the distinction of a specific book 250, 251, 252, 253, 254 from other books. Therefore, it is possible for an RFID system to enable an anti-counterfeit process if required according to identification code of the RFID tag. In this embodiment, the RFID library slanted cavity device has a metal box 261, 262, 263, 264 that is composed of five metal plates, i.e. a front plate, a rear plate, a left plate, a right plate and a bottom plate, and is used for receiving an RFID reader antenna 241, 242, 243, 244 therein, whereas the RFID reader antenna 241, 242, 243, 244 is connected to a RFID reader in a manner selected from the group consisting of: the RFID reader antenna is electrically connected to and integrated with the RFID reader, and the RFID reader antenna is connected to the RFID reader through a RF coaxial cable. Moreover, it is noted that when the RFID reader is electrically connected to the RFID reader antenna 241, 242, 243, 244, the RFID reader is also being receiving inside the metal box 261, 262, 263, 264; and when RFID reader is connected to the RFID reader antenna 241, 242, 243, 244 through a RF coaxial cable, the RFID reader is arranged outside or inside metal box 261, 262, 263, 264; depending upon actual design requirements. It is noted that the best way to position the RFID reader antenna 241, 242, 243, 244 is to place the RFID reader antenna 241, 242, 243, 244 horizontally on the bottom plate of the metal box 261, 262, 263, 264, since by such positioning of the RFID reader antenna 241, 242, 243, 244, the electromagnetic wave leakage can be reduced. However, the RFID reader antenna 241, 242, 243, 244 can be positioned in other manner, as shown in FIG. 2B. Nevertheless, the range of electromagnetic wave leakage should be considered with respect to the positioning of the RFID reader antenna 241, 242, 243, 244 so as to enable a book management operation to be performed smoothly. In addition, the RFID reader used in the present invention is designed to emit electromagnetic wave through the RFID reader antenna 241, 242, 243, 244 so as to interrogate with an RFID tag attached to a book or an audio/video multimedia item. In the present invention, the RFID reader antenna 241, 242, 243, 244 can be an antenna selected from the group consisting of: a circular polarization antenna, a dual polarization antenna, and a linear polarization antenna, among which the circular polarization antenna and the dual polarization antenna are preferred since they are capable of detecting the RFID tag attached on the book 250, 251, 252, 253, 254 no matter how the book 250, 251, 252, 253, 254 is being orientated and placed. On the other hand, if the linear polarization antenna is selected to be used as the RFID reader antenna 241, 242, 243, 244, the book must be orientated accordingly to the polarization direction of the linear polarization antenna so as to be detected properly, since when it is being orientated perpendicular to the polarization direction, the RFID tag might not be able to be accessed by the RFID reader antenna 241, 242, 243, 244.

Similarly, there is a non-metallic slanted plate 221, 222, 223, 224 disposed inside the metal box 261, 262, 263, 264 in a manner that one end of the non-metallic slanted plate 221, 222, 223, 224 is arranged near to the top rim of the metal box 261, 262, 263, 264 while allowing another end thereof to be arranged near to the top of the RFID reader antenna, where it is coupled to a non-metallic baffle 231, 232, 233, 234. The non-metallic slanted plate 221, 222, 223, 224 is provided for allowing items, such as books, to be placed thereon; and by the near perpendicular angle formed between the non-metallic baffle 231, 232, 233, 234 and the non-metallic slanted plate 221, 222, 223, 224, the non-metallic baffle 231, 232, 233, 234 is provided for supporting the items that are placed on the non-metallic slanted plate 221, 222, 223, 224 so as to enable those items to stack on one another in a near vertical standing position. Therefore, the non-metallic slanted plate 221, 222, 223, 224 should be formed with a length much longer than that of the non-metallic baffle 231, 232, 233, 234, whereas the length of non-metallic baffle 231, 232, 233, 234 that is extending in a direction perpendicular to the non-metallic slanted plate 221, 222, 223, 224 should be limited for providing easy access to the items that are placed on the non-metallic slanted plate 221, 222, 223, 224. As shown in FIG. 2A, FIG. 2B, FIG. 2C and FIG. 2D, since the width of a normal book 250 is generally ranged between 14 cm and 20 cm, the non-metallic baffle 231, 232, 233, 234 is preferred to be formed with a height 230 ranged between 5 cm and 12 cm, but is not limited thereby. Since most books or audio/video multimedia items are formed as a rectangle, the included angle that is formed between the non-metallic slanted plate 221, 222, 223, 224 and the non-metallic baffle 231, 232, 233, 234 is preferred to be a 90-degree angle, by that not only there can more items to be placed and stacked on the non-metallic slanted plate 221, 222, 223, 224, but also the RFID tags attached to those items can be accessed easily and effectively.

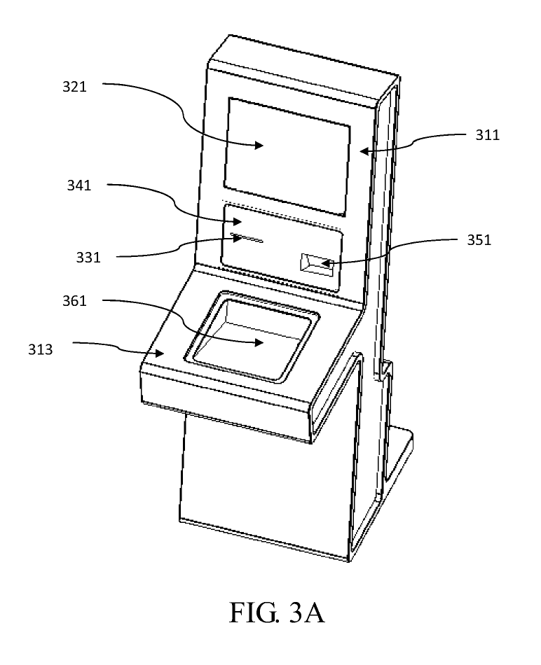

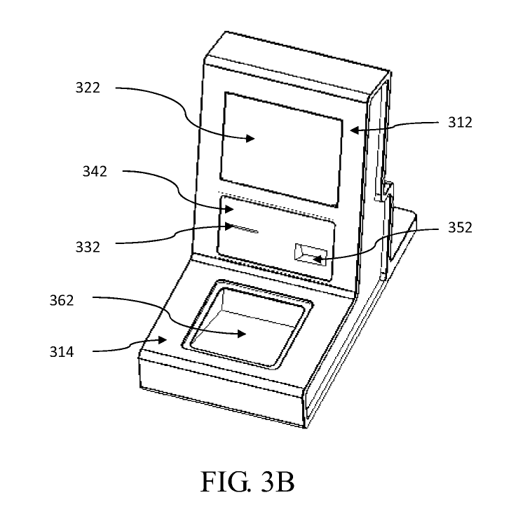

Please refer to FIG. 3A and FIG. 3B, which are schematic diagrams showing respectively a vertical-type automatic book self-service machine and a seat-type automatic book self-service machine. The function of any automatic book self-service machine includes: user ID identification, book self-service operation, an operation for updating the book status registered in internal memories of RFID tags, receipt/message printing, and on-line data exchanging with an integrated library system (ILS), and so on. As shown in FIG. 3A and FIG. 3B, either a vertical-type automatic book self-service machine 311 or a seat-type automatic book self-service machine 312 is configured with an operation platform 313, 314, a touch screen 321, 322, a controller, a printer, a print-out gate 331, 332, an user ID identification device 351, 352 and an RFID library slanted cavity device 361, 362. It is noted that the controller can be a personal computer, an industrial computer, an embedded control card, a micro processor control card, a programmable controller, etc., in which a book self-service software is programmed in the controller for enabling a book borrow/return operation to be controlled and operated through the touch screen 321, 322. In a condition when an embedded control card or a micro processor control card is used as the controller, either the embedded control card or the micro processor control card can similarly be programmed with the book self-service software, or the embedded control card or the micro processor control card can be connected to an internal computer or an external computer whichever is programmed with the book self-service software, so that a book borrow/return operation can be performed through the touch screen 321, 322. The user ID identification device 351, 352 is configured with an RFID reader and corresponding RFID reader antenna, or barcode readers that are programmed with the communication protocol conforming to the communication protocol used in the user ID according to the specification of a book management system, by that a user ID identification operation can be performed. If a barcode reader is used, it is preferred to orientate the barcode reader for allowing a scanning light emitted therefrom to be projected downward to a groove formed in the user ID identification device 351, 352, so as to prevent the light from being projected directly toward human eyes. Moreover, the RFID library slanted cavity device 361, 362 is installed inside the operation platform 313, 314 and is provided for items, such as books or audio/video multimedia items, to be placed thereon so as to enable the RFID tags attached to the items to be accessible and identified. The result of a book borrow/return operation can be printed out by the use of the printer, whereas the output paper containing the operation result is issued through the print-out gate 331, 332. In addition, there can be a maintenance door plate 341, 342 formed on either the vertical-type automatic book self-service machine 311 or the seat-type automatic book self-service machine 312, which is used for loading paper to the printer or other maintenances. It is noted that whether the user ID identification device 351, 352 should be disposed at a position proximate to the maintenance door plate 341, 342 can be determined according to the functionality design of the book management system.

In addition, the RFID library slanted cavity device of the present invention can be adapted for processing audio/video multimedia items, such as disc, video tape, cassette, memory card, and so on, in which the disc includes compact disk (CD), video compact disk (VCD), digital compact disk (DVD), laser disk (LD), compact disk read only memory (CD-ROM), and the like. Moreover, the RFID library slanted cavity device of the present invention can be adapted for processing books, such as booklets, brochures, documents, archives, file folders, and so on. The RFID library slanted cavity device of the present invention can be adapted for a book management operating system, such as an automatic book self-service machine, a library staff workstation, a RFID tag converting station, and a mobile library book cart, whereas the functions of the library staff workstation include: on-line data exchanging with an integrated library system, book borrowing and returning, collection searching, book reservation, barcode/RFID tag encoding and processing, record nullifying, and so on; the RFID tag converting station is used for barcode/RFID tag encoding and tagging, and on-line/off-line data exchanging with an integrated library system; the mobile library book cart is used for inventory, updating the book status registered in internal memories of RFID tags, and on-line/off-line data exchanging with an integrated library system. It is noted that in addition to book management operating system, the RFID library slanted cavity device of the present invention can be adapted for processing other book-like items, only if such book-like items have RFID tags attached thereat. Other then the slanted plate 121, 123, 124 shown in FIG. 1A to FIG. 1D that is arranged sloping from the front of the metal box to rear thereof, it can be arranged to slope from the left to the right of the metal box, or any other way at will, only if such arrangement not only can effectively enhance the efficiency of the RFID readers to access the RFID tags attached to the books or multimedia items, but also can effectively lower the output power of the RFID readers for reducing electromagnetic wave leakage to ambient environment while still working with satisfactory access efficiency. In addition, the accuracy and convenience of a self-service operation can be enhanced by the ergonomics design of the RFID library slanted cavity device of the present invention

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A radio frequency identification (RFID) library slanted cavity device adapted for a book management operating system so as to be used for processing an item, comprising:
a metal box;
at least one RFID tag, each having an identification code registered in an internal memory of the RFID tag and provided to be attached to the item for identification;
an RFID reader antenna, disposed inside the metal box for sensing the at least one RFID tag that is attached to the item while transmitting a sensing signal to an RFID reader; and
a non-metallic slanted cavity, disposed inside the metal box to be provided for the item having the RFID tag attached thereto to be placed thereon so as to enable a book management operation.

2. The RFID library slanted cavity device of claim 1, wherein the RFID reader antenna is connected to the RFID reader for enabling the RFID reader to access the at least one RFID tag in a manner selected from the group consisting of: the RFID reader antenna is electrically connected to the RFID reader when the RFID reader is embedded in the RFID library slanted cavity device, and the RFID reader antenna is connected to the RFID reader through a RF coaxial cable when the RFID reader is arranged outside the RFID library slanted cavity device; and the item is an object selected from the group consisting of: a book and an audio/video multimedia item.

3. The RFID library slanted cavity device of claim 1, wherein the RFID reader antenna is an antenna selected from the group consisting of: a circular polarization antenna, a dual polarization antenna, and a linear polarization antenna.

4. The RFID library slanted cavity device of claim 1, wherein the at least one RFID tag is substantially an ultra-high-frequency (UHF) RFID tag.

5. The RFID library slanted cavity device of claim 1, wherein the non-metallic slanted cavity is made of a non-metallic material, and is provided for the item to be placed thereat so as to enable the book management operation to be performed upon the at least one RFID tag; and the non-metallic material is a material selected from the group consisting of: plastic, wood, paper, ceramics and glass.

6. The RFID library slanted cavity device of claim 1, wherein the metal box is composed of five metal plates, including a front plate, a rear plate, a left plate, a right plate and a bottom plate, and by the shielding of those five metal plates, the electromagnetic wave emitting from the RFID reader antenna is restricted to be transmitted upward through the top of the metal box.

7. The RFID library slanted cavity device of claim 1, wherein the non-metallic slanted cavity is composed of a non-metallic slanted plate, a non-metallic baffle and two non-metallic sidewalls.

8. The RFID library slanted cavity device of claim 7, wherein the non-metallic baffle is formed with a height ranged between 4 cm to 15 cm.

9. The RFID library slanted cavity device of claim 7, wherein the non-metallic slanted plate is disposed forming an included angle ranged between 80 degrees and 110 degrees inside the non-metallic slanted cavity

10. The RFID library slanted cavity device of claim 1, wherein the book management operating system is a device selected from the group consisting of: an automatic book self-service machine, a library staff workstation, a RFID tag converting station, and a mobile library book cart.
